(19) United States
(12) Patent Application Publication
(10) Pub. No.: US 2003/0199289 A1
(43) Pub. Date: Oct. 23, 2003

(54) Mobile phone with an SIM card being installed between a keypad supporting plate and a circuit board

(76) Inventors: Hsiang-Lung Kao, Taipei (TW); Kuo-Hsiang Wu, Taipei (TW); Yung-Fa Cheng, Taipei (TW)

Correspondence Address: RABIN & CHAMPAGNE, PC, 1101 14TH STREET, NW, SUITE 500, WASHINGTON, DC, 20005, US

(21) Appl. No.: 10/317,180

(22) Filed: Dec. 12, 2002

(30) Foreign Application Priority Data
Apr. 19, 2002 (TW) 091205375

(51) Int. Cl. H04B 1/38; H04M 1/00

(52) U.S. Cl. 455/575.1; 455/558

(57) ABSTRACT

A mobile phone with a keypad supporting plate and a circuit board includes at least a subscriber identity module (SIM) card connector, wherein the SIM card connector is installed between the keypad supporting plate and the circuit board and is electrically connected to the circuit board. Moreover, such mobile phone can further include a plurality of SIM card connectors wherein these SIM card connectors are installed between the keypad supporting plate and the circuit board and are electrically connected to the circuit board. By means of control software, such mobile phone selects one SIM card connector from among several and makes the selected one enabled. In practice, a mobile phone can be equipped with a slot on its lateral side through which an SIM card can be connected to or disconnected from an SIM card connector.

This application incorporates by reference of Taiwan application Serial No. 091205375, filed Apr. 19, 2002.

### BACKGROUND OF THE INVENTION

1. Field of the Invention

The invention relates in general to a mobile phone, and more particularly to a mobile phone with a subscriber identity module (SIM) card being installed between a keypad supporting plate and a circuit board.

2. Description of the Related Art

Along with the rapid growth in the industry of electronic products and advance in technology, new communication products are constantly brought forth and marketed. In recent years, portable electronic products, the mobile phone for example, which cover a versatile range of functions, have become a necessity to the public in their everyday life.

Please refer to FIG. 1, a diagram of the internal structure of a conventional mobile phone. A conventional mobile phone 100 mainly includes an outer casing 110, a panel 120, a keypad supportive plate 130 and a circuit board 140. Generally, SIM card connector 150, SIM card 160, element area 170 and battery 180 are installed in the space to the right of the circuit board 140 as shown in the diagram. Normally there is only one set of SIM card 150 and SIM card connector 160 whereas the battery 180 is installed to the right of the SIM card 160 where the outer casing 110 is near as shown in the diagram. Such mobile phone 110 has a number of disadvantages. First, if the panel 120 is a chromatic panel, the mobile phone 100 will become thicker because a larger thickness is required for a chromatic panel. Next, since the SIM card 160 is situated to the left of the battery 180, the battery 180 needs to be unloaded first before the SIM card 160 can be installed or uninstalled which causes lots of inconvenience. Last, since both the SIM card connector 150 and the element area 170 are situated at the same side of the circuit board 140 where the space is limited, normally only one SIM card connector 150 can be installed.

For the mobile phone with a monochrome panel, the overall thickness will only be slightly influenced because the monochrome panel has a small thickness itself However, since the chromatic panel is getting more and more popular, the overall thickness of a mobile phone will become thicker because a thicker chromatic panel is used. Therefore, how to meet the design requirements of a mobile phone: lightness, thinness, shortness, and smallness, given the situation that a chromatic panel is used without increasing the overall thickness of a mobile phone has become a great challenge in the research and development of mobile phone.

It can be known from the foregoing disclosure that a conventional mobile phone has the following disadvantages:

1. The thickness of a conventional mobile phone cannot be effectively reduced. If a thicker panel is used, a chromatic panel for example, the thickness of a mobile phone will be increased accordingly so the design requirement of lightness, thinness, shortness, and smallness cannot be satisfied.

2. Inconvenient installment/un-installment of the SIM card. The battery needs to be unloaded first before the SIM card can be installed or un-installed causing inconvenience to the use of a conventional mobile phone.

3. A conventional mobile phone can only have one set of phone number. Subject to the internal structure and circuit allocation, a mobile phone can only be installed with one SIM card connector. That is to say, only one SIM card can be installed thus only one set of phone number is allowed.

### SUMMARY OF THE INVENTION

It is therefore an object of the invention to provide a mobile phone for the following purposes:

1. To reduce the thickness of a mobile phone effectively. Given the situation that a thicker chromatic panel is used, the overall thickness of a mobile phone can still be maintained without being increased so the design requirements of a mobile phone: lightness, thinness, shortness, and smallness can be satisfied.

2. Make the installment/un-installment of an SIM card easy. When installing or un-installing an SIM card, the prior unloading of battery which causes inconvenience to the user of a mobile phone is no more needed.

3. Enable a mobile phone to have a plurality of phone numbers. The internal structure and circuit allocation of a mobile phone are re-arranged so that a plurality of SIM card connectors can be installed inside the mobile phone accommodating a plurality of SIM cards. Therefore a plurality of phone numbers can be assigned.

The invention achieves the above-identified objects by providing a mobile phone whose structural features are briefed as follows.

A mobile phone with a keypad supporting plate and a circuit board includes at least an SIM card connector, wherein SIM card connector is installed between the keypad supporting plate and the circuit board and is electrically connected to the circuit board. Moreover, such mobile phone can further include a plurality of SIM card connectors wherein these SIM card connectors are installed between the keypad supporting plate and the circuit board and are electrically connected to the circuit board. By means of control software, such mobile phone selects one SIM card connector from among several and makes the selected one enabled. In practice, a mobile phone can be equipped with a slot on its lateral side through which an SIM card can be connected to or disconnected from an SIM card connector.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1, a diagram shows the internal structure of a conventional mobile phone;

FIG. 2, a diagram shows the internal structure of a mobile phone according to a preferred embodiment of the invention;

FIG. 3, a diagram shows the internal allocation of a mobile phone with a plurality of SIM card connectors according to a preferred embodiment of the invention; and

FIG. 4, a diagram shows the method to install or un-install an SIM card from a mobile phone according to a preferred embodiment of the invention.

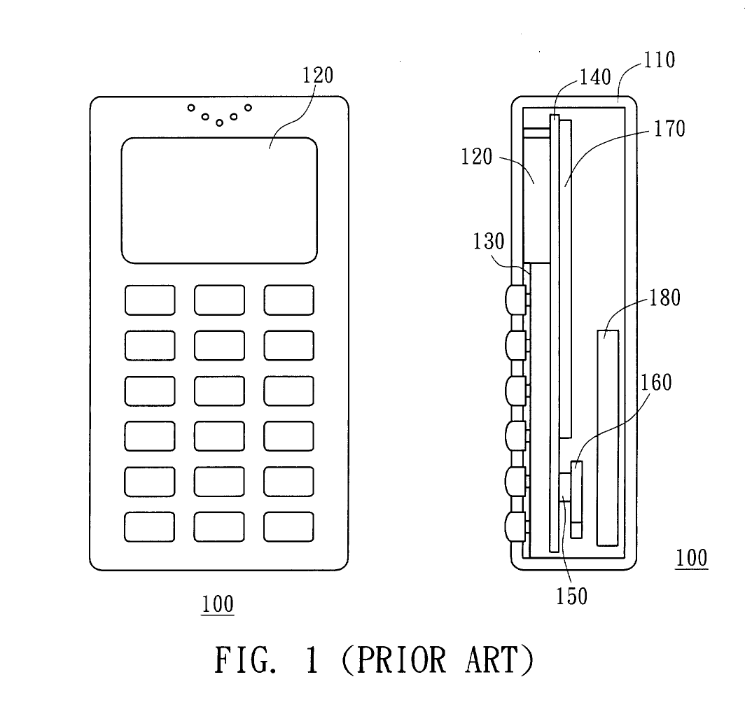

### DETAILED DESCRIPTION OF THE INVENTION

The key point for the mobile phone according to the invention is that a mobile phone with a chromatic panel requires a large volume of space due to a larger volume of the panel itself As a consequence, the overall thickness of the mobile phone will be increased and thus cannot meet the design requirements of lightness, thinness, shortness, and smallness. Since the panel thickness is increased, the first space between the keypad supporting plate and the circuit board will be increased accordingly. Therefore, the SIM card connector, which is originally installed in the second space between the circuit board and the outer casing of the mobile phone, can be re-allocated to the first space. Although the first space becomes thicker due to a larger volume of the panel, the second space becomes thinner after the SIM card connector is re-allocated to the first space. Therefore, the overall thickness of the mobile phone will not increase despite of an increase in thickness of the panel. While the SIM card connector is no more allocated in the second space where the battery is installed, there is no need to unload the battery first for the SIM card connector to be installed or un-installed. Furthermore, originally the second space can only accommodate an SIM card connector, but the first space can now accommodate a plurality of SIM card connectors due to an increase in the thickness of the panel. The practical embodiment will be disclosed hereinafter.

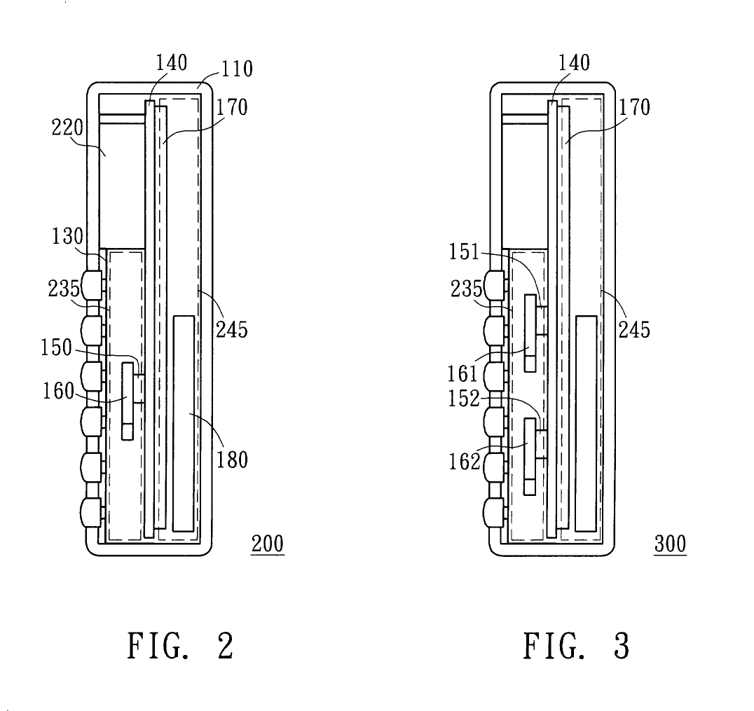

Please refer to FIG. 2, a diagram showing the internal structure of a mobile phone according to a preferred embodiment of the invention. A mobile phone 200 mainly includes a keypad supporting plate 130, a circuit board 140 and an SIM card connector 150, wherein the SIM card connector is installed between the keypad supporting plate 130 and the circuit board 140 and is electrically connected to the circuit board 140. The space between the keypad supporting plate 130 and the circuit board 140 can be defined as the first space 235 and the space between the circuit board 140 and the outer casing 110 the second space 245. Referring to the diagram, the areas covered by the two spaces are enclosed and shown in dotted lines. Comparing with the internal structure of a conventional mobile phone, panel 220 has a larger thickness because the panel 220 here can be a chromatic one, so the first space 235 will increase accordingly. As a result, the overall thickness of the mobile phone 200 will be increased as well so the design requirements of lightness, thinness, shortness, and smallness cannot be satisfied. In order not to increase the overall thickness of the mobile phone 200, the SIM card connector 150, which was originally installed in the second space, is now shifted to the first space 235 whose thickness is now increased due to an increase in the thickness of the panel 220. While the second space 245, which was originally installed with the SIM card connector 150, becomes thinner now because the SIM card connector 150 has already been removed.

While the first space 235 becomes thicker due to an increase in the thickness of the panel 220, the space increased can be used to accommodate the SIM card connector 150 which was originally installed in the second space 245 allowing the second space to reduce its thickness. Although the thickness of the first space 235 is increased, the thickness of the second space is reduced accordingly. On the whole, the mobile phone 200 will not increase its thickness.

Moreover, since the SIM card connector 150 has now been re-allocated to the first space 235, the inconvenience which arises when the SIM card 150 was allocated in the second space 245 where the battery 180 is installed has now been solved. There is no need to unload the battery first for the SIM card connector 150 to be installed or un-installed now.

Please refer to FIG. 3, a diagram showing the internal allocation of a mobile phone with a plurality of SIM card connectors according to a preferred embodiment of the invention. For a conventional mobile phone, since the element area 170 is installed on the circuit board 140 in the second space 245, the SIM card connector can only be installed in the space left. Under this circumstance, normally only one SIM card connector can be installed. After the SIM card connector is shifted to the first space 235, the circuit board 140 can accommodate a plurality of SIM card connectors because the available space has become larger. For example, two SIM card connectors 151 and 152 can be installed allowing mobile phone 300 to use two SIM card 161 and 162 of different phone numbers. Suppose the SIM card 161 with phone number A and the SIM card 162 with phone number B, the mobile phone 300 can select an SIM card connector between the SIM card 161 and 162 and make it enabled for the user to choose his or her desired phone number. If the user wants to use phone number A, only the SIM card 161 will be enabled; if the user wants to use phone number B, only the SIM card 162 will be enabled. So the user can have two different phone numbers for the same mobile phone.

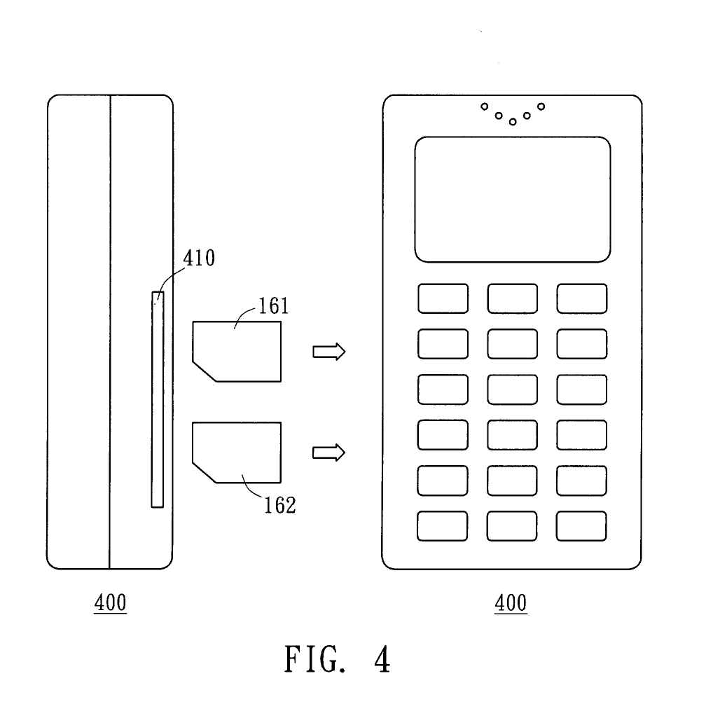

Please refer to FIG. 4, a diagram showing the method to install or un-install an SIM card from a mobile phone according to a preferred embodiment of the invention. The lateral side of the mobile phone 400 can be equipped with a slot 410 through which the SIM card 161 and 162 can be connected to or disconnected from the SIM card connector. Comparing with the conventional method for the installment and un-installment of the SIM card, which needs to open the outer casing of a mobile phone or even needs to unload the battery first, such new method is of no doubt more convenient and efficient.

The design of a mobile phone as disclosed in the above description not only corrects the shortcoming of a conventional mobile phone that the overall thickness will increase when a chromatic panel is used, but also creates a number of advantages. For example, such mobile phone can be installed with a plurality of SIM card connectors to accommodate a plurality of SIM cards; the SIM card can be installed or un-installed via a slot; by means of control software, an SIM card can be selected and used from among several.

It is noteworthy that the geometric structure for the parts and elements described in the embodiment of the invention should be regarded as an example of an embodiment of the invention and should not be used to limit the application of the invention. Anyone who is familiar the technology of the invention can make necessary adjustments to achieve a similar function without violating the spirit of the invention.

The mobile phone according to the invention disclosed in the foregoing embodiment has the following advantages:

1. The thickness of a mobile phone can be effectively reduced. Although the panel becomes thicker (when a chromatic panel is used, for example), the overall thickness of a mobile phone can still be maintained without being increased so the design requirements of a mobile phone: lightness, thinness, shortness, and smallness can be satisfied.

2. The installment/un-installment of an SIM card becomes easier. The SIM card can be installed or un-installed via a slot without having to unload the battery first making the use of a mobile phone easier.

3. Enable a mobile phone to have a plurality of phone numbers. The mobile phone can be installed with a plurality of SIM card connectors to accommodate a plurality of SIM cards. Therefore a plurality of phone numbers can be assigned.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mobile phone with a keypad supporting plate and a circuit board, comprising at least:
a subscriber identity module (SIM) card connector, wherein the SIM card connector is installed between the keypad supporting plate and the circuit board and is electrically connected to the circuit board.

2. The mobile phone according to claim 1, wherein the lateral side of the mobile phone is further equipped with a slot through which an SIM card can be connected to or disconnected from the SIM card connector.

3. A mobile phone with a keypad supporting plate and a circuit board, comprising at least:
a plurality of SIM card connectors, wherein these SIM card connectors are installed between the keypad supporting plate and the circuit board and are electrically connected to the circuit board.

4. The mobile phone according to claim 3, wherein the mobile phone uses control software to select an SIM card connector from among several and makes it enabled.

5. The mobile phone according to claim 3, wherein the lateral side of the mobile phone is further equipped with a slot through which a plurality of SIM cards can be connected to or disconnected from these SIM card connectors.
